(19) United States
(12) Patent Application Publication
(10) Pub. No.: US 2008/0174630 A1
(43) Pub. Date: Jul. 24, 2008

(54) DIE COATING TO INCREASE PRINTING SPEED AND QUALITY

(75) Inventor: Scott A. Boyd, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/970,859

(22) Filed: Jan. 8, 2008

Related U.S. Application Data
(60) Provisional application No. 60/886,420, filed on Jan. 24, 2007.

(51) Int. Cl. B41J 2/015; B41F 33/00

(52) U.S. Cl. 347/20; 101/483

(57) ABSTRACT

An improved print head includes a die coating apparatus to die coat the cable. Thus the wire or cable would pass through a die coating apparatus instead of the reservoir of ink described in the above-identified patents. Die coating the cable offers increased control of the amount of ink that adheres to the cable and thus facilitates the production of a high resolution final image on the print medium. Die coating also increases the speed at which an image can be printed on the print medium. Lastly, die coating will enable the print head to be a closed system, minimizing the presence of dirt and dust particles in the ink.

### BACKGROUND

One known printer technology includes a print head that (1) immerses a wire in a reservoir of pigmented liquid material (e.g., ink) for a period of time sufficient to allow the wire to be coated with ink, (2) places the coated wire in close proximity to a print medium, and (3) directs a stream of air to contact the coated wire and thereby causes at least some of the ink on the wire to be deposited onto the print medium. The speed of the wire, the proximity of the wire to the print medium, and the force of the air stream may be digitally controlled by a processor, controller, microprocessor, or other computing device to ensure that a desired image resolution is achieved. By forming a print head with multiple wires; multiple, differently colored ink reservoirs; and multiple air streams, and by controlling and coordinating the metering of the ink and the position of the print head in relation to the print medium, a digital image can be created on a large-sized print medium. U.S. Pat. Nos. 5,944,893; 5,972,111; 6,089,160; 6,090,445; 6,190,454; 6,319,555; 6,398,869; and 6,786,971 describe this printer technology in greater detail and are incorporated herein by reference.

FIG. 1 is a perspective view of one embodiment of the above-identified prior art single color ink injector, generally indicated at 10, for depositing paint, ink, dye, or other liquid pigmented material that could be used for painting or printing onto a print medium to which a motor 14 is attached. A pulley 13 having a circumscribing groove 38 defined therein is secured to a shaft 15 of motor 14. An elongate frame member 32 depends from and is secured to print medium 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a wire cable 36, can slide during rotation of wheel 13. Wire cable 36 is described in greater detail in the above-identified patents. Wire cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of the ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate.

Rotation of shaft 15 is controlled by a controller, generally indicated at 57, comprising circuitry 54 in a module 56 that receives signals from a signal generating device 52, such as a personal computer employing a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink contained in reservoir 24 is picked up by cable 36 and advanced by rotation of wheel 13, indicated by the arrow, in front of nozzle orifice 46. Air that is blown through nozzle orifice 46 disperses or pulls ink from cable 36 toward the print medium. Depending on the viscosity of the ink, the cross-sectional diameter of cable 36, and the diameter of wheel 13, a relatively precise amount of ink can be deposited on print medium. Such an apparatus may produce images having a resolution of approximately 50 dpi or better.

### SUMMARY

The present application is directed to a method of more accurately applying a uniform coating of pigmented liquid material into the wire.

The present application is directed to increasing the speed at which the above-identified printer technology can print digital images.

The present application is directed to forming a closed system for the above-identified printer technology.

An improved print head includes a die coating apparatus to die coat the cable. Thus the wire or cable would pass through a die coating apparatus instead of the reservoir of ink described in the above-identified patents. Die coating the cable offers increased control of the amount of ink that adheres to the cable and thus facilitates the production of a high resolution final image on the print medium. Die coating also increases the speed at which an image can be printed on the print medium. Lastly, die coating will enable the print head to be a closed system, minimizing the presence of dirt and dust particles in the ink.

One embodiment of a method of printing with the improved print head involves die coating at least a portion of an exterior surface of a cable with a pigmented material. An air stream is directed at the portion of the cable coated with the pigmented material. The force of air in the air stream causes a metered amount of the pigmented material to be removed from the exterior surface of the cable and to be deposited onto a print medium that is placed in close proximity to the cable. Advancement of the cable through the air stream is electronically controlled.

One embodiment of an apparatus for digitally printing a high resolution image on a print medium includes a support structure, a carriage associated with and movable in at least one direction relative to the support structure, and a plurality of paint injectors secured to the carriage. Each of the paint injectors includes a motor having a rotatable shaft, a wheel rotatable by the shaft, an idler, and an elongate segment disposed around at least a portion of the wheel and a portion of the idler. The elongate segment is advanceable by the wheel and has a quantity of pigmented material die coated onto at least a portion of it. The paint injectors also each include at least one fluid nozzle positioned and oriented for directing a jet of fluid toward at least a portion of the elongate segment to remove an amount of pigmented material from the elongate segment and direct the amount toward a surface of a print medium. A controller that is electronically connected to each motor controls the rotation of each wheel and controls the position of the carriage relative to the support structure.

### BRIEF DESCRIPTION OF THE DRAWINGS

FIG. 1 is a perspective view of one embodiment of the prior art single color paint injector.

FIG. 2 is a schematic view of one embodiment of a paint injector in which a die coats the cable with ink.

FIG. 3 is an expanded schematic of the die of FIG. 2.

FIG. 4 is a cross-sectional view of the die of FIG. 2.

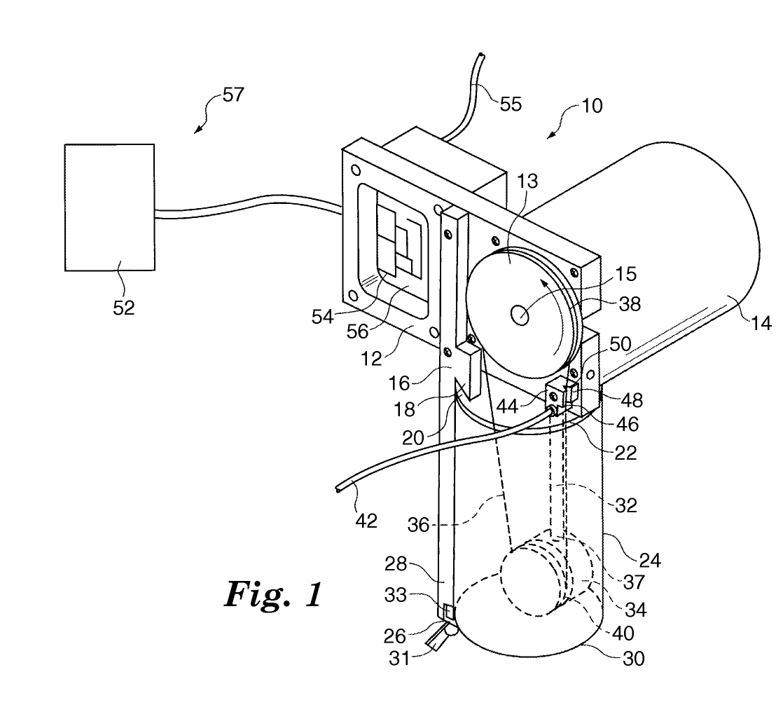

### DETAILED DESCRIPTION

As is described in greater detail in U.S. Pat. Nos. 5,944,893; 5,972,111; 6,089,160; 6,090,445; 6,190,454; 6,319,555; 6,398,869; and 6,786,971, ink clings to the cable during its advance through the ink reservoir, thereby forming a coating of ink on the cable. The thickness of this coating is at least partly controlled by the viscosity of the ink in the reservoir. When highly viscous inks, such as those preferred when forming signage capable of outdoor use, are used, the coating on the cable is very thick. The thickness of the coating on the cable at least partly dictates the size of the ink droplet that is deposited on the print medium. More specifically, when small diameter ink droplets are deposited on the print medium, the final image has a high resolution. Conversely, when larger diameter ink droplets are deposited on the print medium, the final image has a low resolution. Thus when highly viscous inks are used in the printer described in the above-identified patents, the resulting image has a low resolution.

The above-identified patents provide no means for controlling the thickness of the coating other than to regulate the viscosity of the ink in the ink reservoir. Thus these patents fail to describe a printer capable of printing high resolution images using highly viscous inks, such as those highly durable inks preferably used to form outdoor signage. The inventors of the present invention recognized that it would be desirable to have an apparatus for and method of printing a higher resolution image when using highly durable, higher viscosity inks.

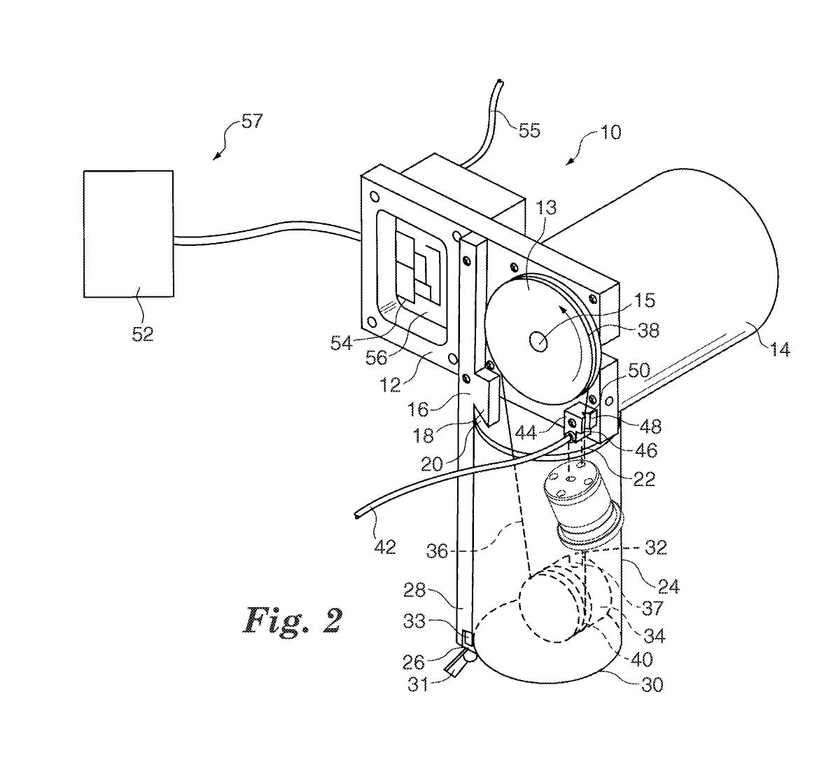

FIG. 2 is a perspective view of one embodiment of a print head 10² including a die 102. A pulley 13 having a circumscribing groove 38 defined therein is secured to a shaft 15 of motor 14. An elongate frame member 32 is secured to an ink pan 100. A rotatable or stationary guide 34 is attached to a distal end 37 of elongate frame member 32. Guide 34 is illustrated as a cylindrical, non-rotatable member having a groove 40 circumscribing guide 34 in which a wire cable 36, can slide during rotation of wheel 13. Wire cable 36 is disposed in groove 38 circumscribing the wheel 13 and in groove 40 circumscribing guide 34. Die 102 is secured to ink pan 100 or print head 10².

An elongate ink pan retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of the ink pan 100 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate.

Rotation of shaft 15 is controlled by a controller, generally indicated at 57, comprising circuitry 54 in a module 56 that receives signals from a signal generating device 52, such as a personal computer employing a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink is fed into die 102 via a tube (not shown). The ink is then deposited onto cable 36 and advanced by rotation of wheel 13, indicated by the arrow, in front of nozzle orifice 46. Air that is blown through nozzle orifice 46 disperses or pulls ink from cable 36 toward the print medium. Depending on the viscosity of the ink, the cross-sectional diameter of cable 36, and the diameter of wheel 13, a relatively precise amount of ink can be deposited on print medium. Such an apparatus may produce images having a resolution of approximately 50 dpi or better.

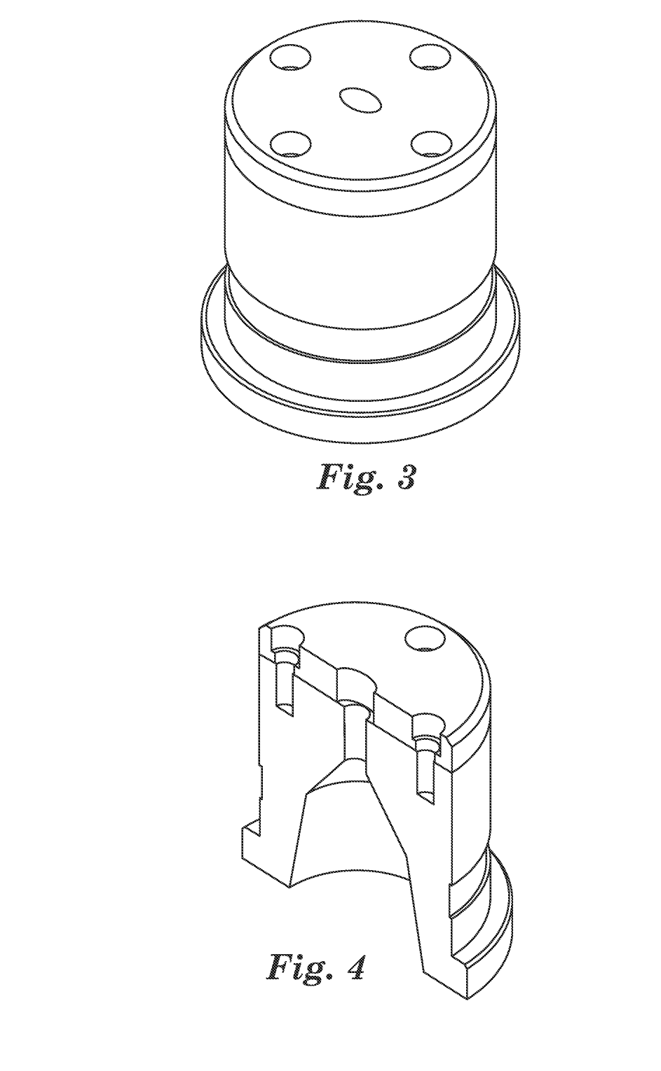

FIGS. 3 and 4 are expanded schematic and cross-sectional views of die 102.

The present inventors recognized that die coating the cable facilitates the use of highly viscous inks to produce high resolution images. Because the die meters and controls the thickness of the coating of ink on the cable, smaller diameter ink droplets can be deposited on the print medium, resulting in the creation of a higher resolution image. Thus the incorporation of a die-coating system in the printer described in U.S. Pat. Nos. 5,944,893; 5,972,111; 6,089,160; 6,090,445; 6,190,454; 6,319,555; 6,398,869; and 6,786,971 permits the user to produce a high resolution image using highly viscous inks.

Further, the speed of the cable's advance through the air stream affects the quantity of ink injected into the air stream. The faster the cable is advancing, the less ink is deposited on the print medium, and the slower the cable is advancing, the greater the amount of ink is deposited on the print medium. The speed of the cable is at least partly determined by the speed at which the cable can be pulled through the ink reservoir, which is largely dictated by the viscosity of the ink in reservoir. By replacing the ink reservoir with a die coating apparatus, the speed at which the cable advances can be increased without significantly affecting the resolution of the final image or the ability to use highly viscous inks. Thus the overall efficiency of the printer can be increased.

Lastly, the use of a die coating apparatus in the printer enables the print head to be formed as a closed system. By creating a closed system in the print head, the presence of dirt and dust particles in the ink is minimized, resulting in a higher resolution image. In contrast, the ink reservoirs described in the above-identified prior art patents were topless cans whose contents were freely exposed to dirt and dust.

As used herein, the term “cable” is meant to include the use of a wire, a cable formed of multiple wires, a rod, a saw tooth wheel, or variations thereof.

As used herein, the term “ink” is meant to include any pigmented material, including, but not limited to, inks, dyes, paints, or other similarly pigmented liquids. Inks that can be printed in the printer of the present invention include inks having a viscosity between about 200 and about 2000. This is a still significantly higher viscosity than can be jetted though conventional ink jet printers. A list of exemplary commercially available inks that fall within this range includes: 3M Process Color Series 700, 3M Process Color Series 880-00, 3M Process Color Series 880i, 3M Process Color Series 990, 3M Scotchlite Transparent Screen Printing Ink Series 2900, 3M Screen Printing Ink Series 1900, 3M Screen Printing Ink Series 9700UV, Nazdar 3500 Series UV Vinex Screen Ink, Avery Dennison Series 4930 Series Inks (10 year-1 Component Solvent Ink*), Sericol UVTS Series Ink, Nazdar UVTS Series Ink, Avery Dennison® UVTS-Sericol Ultraviolet Curable Printing Inks, Avery Dennison® UVTS-NazDar Ultraviolet Curable Printing Inks, Kiwalite KT Series Screen Process Ink, Avery Dennison® 10TS SeriesTwo-Component Printing Inks For Traffic Sign Products, Sericol Sinvacure UV Curable Screen Ink, Avery Dennison® 7TS Series Inks One Component Solvent Ink System For Traffic Sign Products, and Ink Dezyne VP-000 Series Vinyl Plus Screen Ink.

As used herein, the term “print medium” is meant to include any print medium known in the art, including but not limited to paper, plastic, synthetic paper, metal foil, vinyl, and films, and variations thereof.

Any die coating apparatus known to those of skill in the art can be used in the printer of the present invention, including but not limited to, carbide tipped dies; doghouse-type wiper dies; solid dies; universal-type assemblies for square, rectangular, and ribbon wire; split dome dies for round and rectangular wire; crosshead centering dies, and rod die assemblies. Some exemplary die coating manufacturers include Bettner Wire Coating Dies and C.W. Braebender.

Further, multiple print heads each including a die coating apparatus may be used to form a printer capable of printing a high-resolution multi-color image.

Various modifications and alterations of the present invention will become apparent to those skilled in the art without departing from the spirit and scope of the invention.

What is claimed is:

1. A method of forming a high resolution image on a print medium, comprising:
die coating at least a portion of an exterior surface of a cable with a pigmented material;
directing an air stream at the at least a portion of the cable coated with the pigmented material; and
electronically controlling advancement of the cable through the air stream such that a metered amount of the pigmented material is removed from the exterior surface of the cable and is deposited onto a print medium.

2. An apparatus for digitally printing a high resolution image on a print medium, comprising:
a support structure;
a carriage associated with and movable in at least one direction relative to the support structure;
a plurality of paint injectors secured to the carriage, each comprising:
a motor having a rotatable shaft;
a wheel rotatable by the shaft of the motor;
an idler;
an elongate segment disposed around at least a portion of the wheel and a portion of the idler and advanceable by the wheel, the elongate segment having a quantity of liquefied pigmented material die coated onto at least a portion of the elongate segment; and
at least one fluid nozzle positioned and oriented for directing a jet of fluid toward the at least a portion of the elongate segment to remove an amount of liquefied pigmented material from the elongate segment and direct the amount toward a surface; and
a controller electronically connected to each motor for controlling rotation of each wheel and for controlling the position of the carriage relative to the support structure.
